(19) United States
(12) Patent Application Publication
(10) Pub. No.: US 2025/0181384 A1
(43) Pub. Date: Jun. 5, 2025

(54) Task Graph Control of Data Transfer

(71) Applicant: Advanced Micro Devices, Inc., Santa Clara, CA (US)

(72) Inventors: Ali Arda Eker, Bellevue, WA (US); Anthony Thomas Gutierrez, Seattle, WA (US); Stephen Alexander Zekany, Redmond, WA (US)

(73) Assignee: Advanced Micro Devices, Inc., Santa Clara, CA (US)

(21) Appl. No.: 18/524,907

(22) Filed: Nov. 30, 2023

(51) Int. Cl. G06F 9/48

(52) U.S. Cl. CPC G06F 9/4856; G06F 9/4881

(57) ABSTRACT

Task graph control techniques for data transfer are described. The task graph control techniques are usable to aggregate data from multiple tasks into an aggregated data transfer, thereby improving operational efficiency and device performance. In a first example, a runtime scheduler executed on a command processor is implemented to select a node during execution of tasks of the task graph. The selected node is assigned by the runtime schedule to transfer aggregated data from that node and parent of that node. In a second example, a compiler of a host device is tasked with generating the task graph. As part of generating the task graph, the compiler also inserts one or more data transfer nodes. The location of the data transfer node within the task graph by the compiler is used to specify when a data transfer is to be performed.

### GOVERNMENT RIGHTS

This invention was made with Government support under Contract No. H98230-22-C-0152 awarded by the Department of Defense. The Government has certain rights in this invention.

### BACKGROUND

A task graph is used by a host device to schedule tasks to be performed by processing elements of an auxiliary processing device, e.g., an accelerator device, a graphics processing unit, and so forth. The task graph includes nodes that represent tasks to be performed and are connected with edges that define data dependencies between the tasks. Data dependences entail that a producer node in the task graph perform a data transfer to a consumer node in the task graph, which can then perform an associated task. In some real-world scenarios, however, data transfers as implemented by conventional techniques introduce technical challenges and hinder system performance.

### BRIEF DESCRIPTION OF THE DRAWINGS

The detailed description is described with reference to the accompanying figures.

FIG. 1 is a block diagram of a non-limiting example system configured to employ task graph control of data transfer techniques.

FIG. 2 is a block diagram of a non-limiting example system configured to employ task graph control of data transfer techniques in which a runtime scheduler employs a counter to detect when to initiate a data transfer based on a task graph.

FIG. 3 is a flow diagram depicting a step-by-step procedure in an example implementation of operations performable by a processing device for accomplishing a result of task graph control of data transfer using a runtime schedule implemented by a command processor.

FIG. 4 is a block diagram of a non-limiting example system configured to employ task graph control of data transfer techniques in which a compiler inserts a data transfer node as part of a task graph.

FIG. 5 is a flow diagram depicting a step-by-step procedure in an example implementation of operations performable by a processing device for accomplishing a result of task graph control of data transfer using a compiler to insert a data transfer node as part of a task graph.

### DETAILED DESCRIPTION

### Overview

Tasks graphs are usable by a host device to schedule tasks to be performed by an auxiliary processing device, e.g., a graphics processing unit, accelerator device, and so on. Nodes of the task graph are used to represent the tasks to be performed and edges that connects the nodes represent data dependencies involving a data transfer between the nodes. A first node, for instance, is usable to specify capture of a digital image and a second node, connected to the first node via an edge, is then tasked with applying a filter to the digital image. Therefore, the first node in this example is a producer node and the second node is a consumer node that has a data dependency from the first node, in which, a task performed by the consumer node is not performed until completion of a corresponding task by the producer node. Task graphs find use in parallel and distributed computing environments and support efficient scheduling of tasks based on available resources, ensure tasks are executed in a correct order, and also maximize concurrency, e.g., parallel processing.

In some real-world scenarios, however, data dependencies specified in the task graph introduce operation inefficiencies and technical challenges resulting from these inefficiencies. A task graph, for instance, is configurable to include a multitude of nodes, with each edge specifying a data transfer to be performed by a producer node to satisfy a data dependency with a consumer node. Even in instances in which an amount of data to be transferred is relatively small (e.g., a small number of bytes), a relatively large number of data transfers may be involved, which is proportional to a number of edges in the task graph. Frequent performance of data transfers for each producer node to copy this small amount of data is detrimental to system performance, especially in fine-grained tasks graphs having many edges and is particularly problematic for nodes that are relatively far apart in the task graph, e.g., involve multiple hops in a tiled architecture.

To address these and other technical challenges, task graph control techniques for data transfer are described. The task graph control techniques are usable to aggregate data from multiple tasks into an aggregated data transfer, thereby improving operational efficiency and device performance.

In a first example, a runtime scheduler executed on a command processor of an auxiliary processing device is implemented to select a node during execution of tasks of the task graph. The selected node is assigned by the runtime scheduler to transfer aggregated data from that node and parent of that node, i.e., from which the node has a data dependency. In one or more examples, the runtime scheduler does so by using a counter having a value based on a number of data dependencies identified from the task graph. The value of the counter is adjusted for each corresponding task when scheduled by the runtime scheduler.

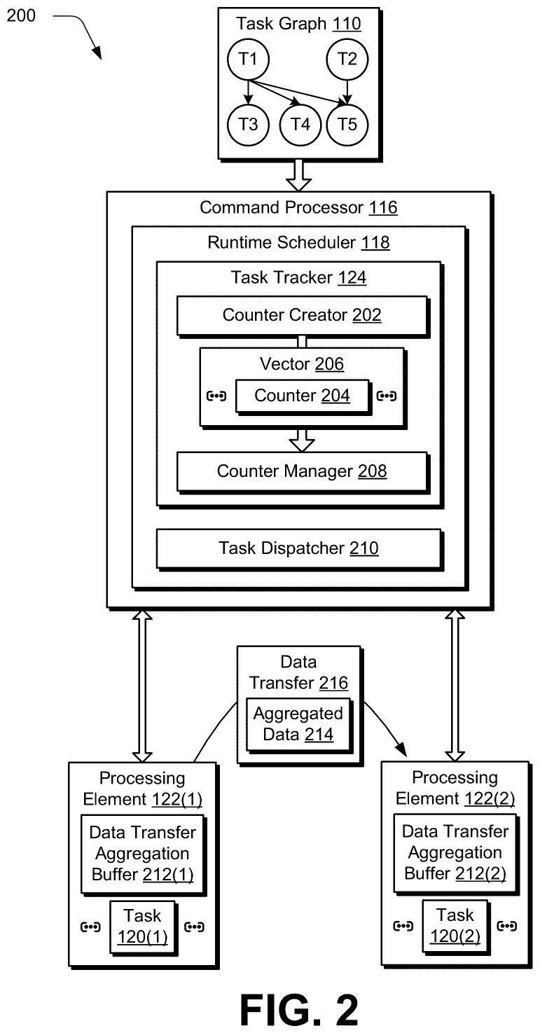

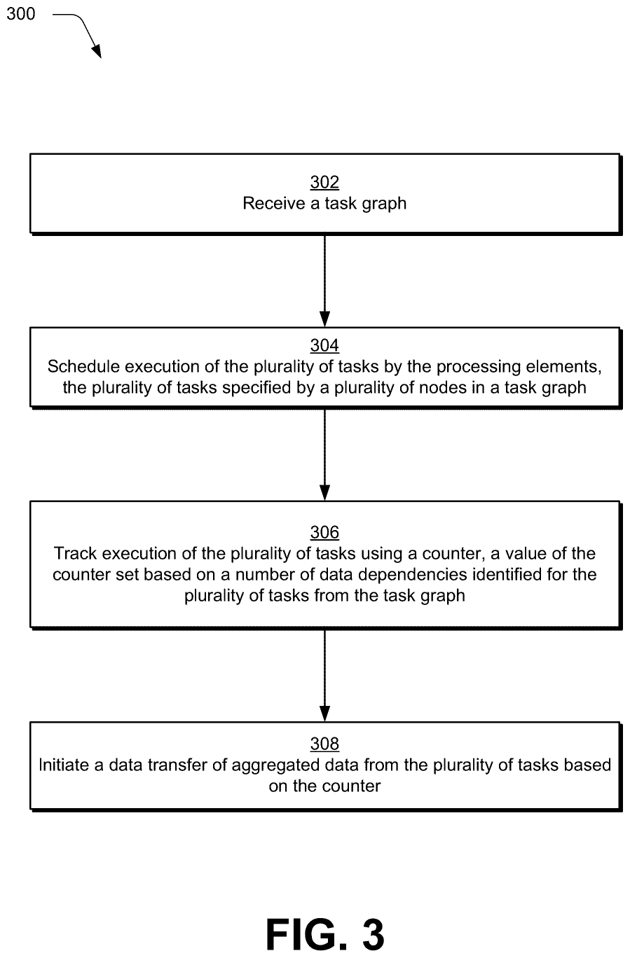

Upon detecting that a value by the counter indicates that a corresponding node and tasks specified by that node no longer have a data dependency, the data transfer is assigned to that node by the runtime scheduler to transfer data aggregated from the node and the parent nodes. In this way, the technical challenges of conventional techniques caused by frequent data transfers using relatively small amounts of data are addressed, further discussion of which may be found in relation to FIGS. 2-3.

In a second example, a compiler of a host device is tasked with generating the task graph. As part of generating the task graph, the compiler also inserts one or more data transfer nodes alongside computation nodes that specify tasks to be performed as described above. The location of the data transfer node within the task graph by the compiler is used to specify when a data transfer (e.g., a direct memory access) is to be performed. As part of determining where to insert the data transfer node, the compiler may address a variety of cost considerations. Examples of cost considerations include a cost associated with an amount of time to perform data aggregation, a cost associated with performing multiple data transfer operations to transfer the data, and so forth.

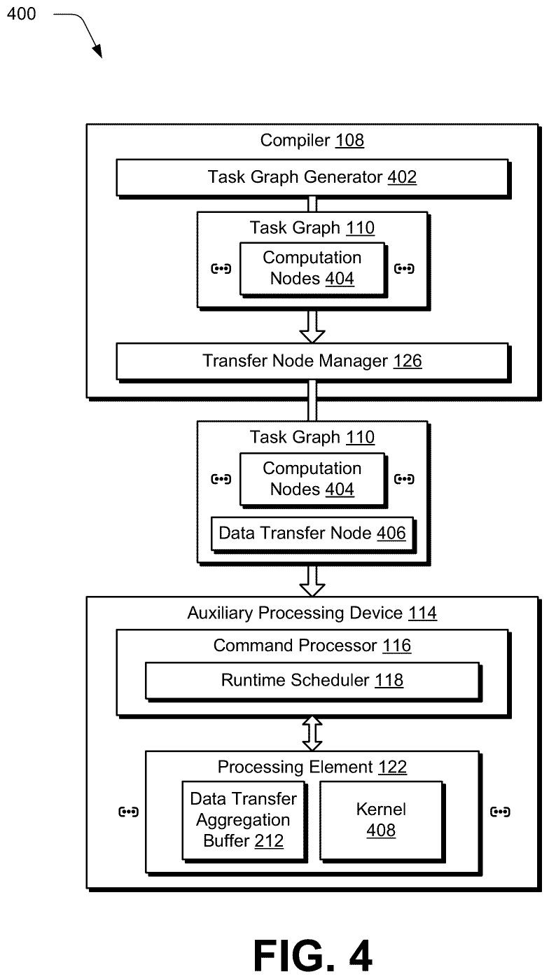

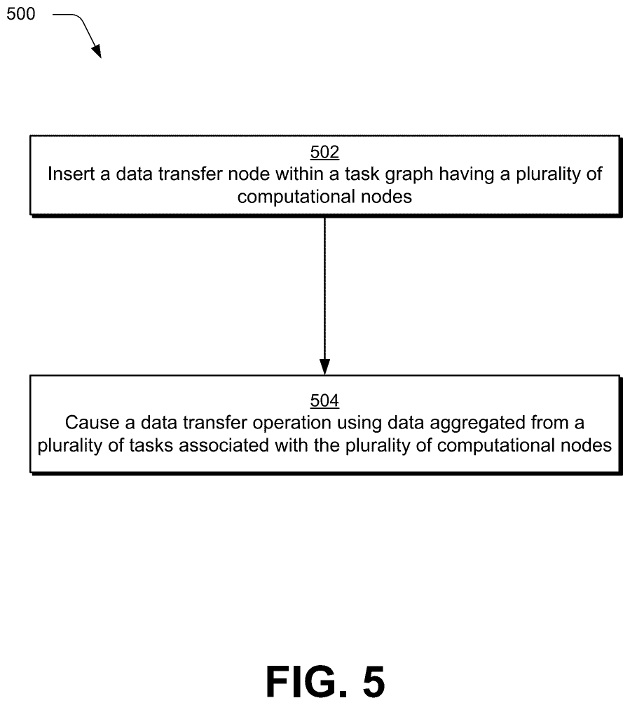

The data transfer node, in one or more examples, is then interpreted by the command processor (e.g., a runtime scheduler) to generate a first data packet to initiate a direct memory access operation on a processing element associated with a producer node that is to transmit the aggregated data. The command processor also interprets the data transfer node to generate a second data packet configured to complete the direct memory access operation on another processing element associated with a consumer node that is to receive the data. Likewise, the technical challenges of conventional techniques caused by frequent data transfers using relatively small amounts of data are addressed, further discussion of which may be found in relation to FIGS. 4-5.

In some aspects, the techniques described herein relate to a device including processing elements configured in hardware using circuitry for executing a plurality of tasks, and a command processor configured in hardware using circuitry to: schedule execution of the plurality of tasks by the processing elements, the plurality of tasks specified by a plurality of nodes in a task graph, track execution of the plurality of tasks using a counter, a value of the counter is set based on a number of data dependencies identified for the plurality of tasks from the task graph, and initiate a data transfer of aggregated data from the plurality of tasks based on the counter.

In some aspects, the techniques described herein relate to a device, wherein the plurality of nodes in the task graph are coupled using a plurality of edges that indicate the data dependencies between respective nodes of the plurality of nodes.

In some aspects, the techniques described herein relate to a device, wherein the command processor is configured to initiate the data transfer responsive to detecting that the counter indicates a respective task of the plurality of tasks does not include a further data dependency.

In some aspects, the techniques described herein relate to a device, further including a data transfer aggregation buffer, associated with a respective processing element of the plurality of processing elements, configured to store the aggregated data.

In some aspects, the techniques described herein relate to a device, wherein the data transfer aggregation buffer is configured to maintain the aggregated data as: a plurality of values that include data from respective tasks of the plurality of tasks, and a plurality of indices that correspond to the plurality of tasks.

In some aspects, the techniques described herein relate to a device, the command processor is configured to perform a runtime check to detect overflow of the data transfer aggregation buffer.

In some aspects, the techniques described herein relate to a device, wherein the command processor is configured to initiate the data transfer by dispatching a data transfer packet to a respective processing element of the processing elements that executes a respective task of the plurality of tasks that is indicated by the counter as not having a data dependency with another task of the plurality of tasks.

In some aspects, the techniques described herein relate to a system including a processor configured in hardware using circuitry to perform one or more operations, and a memory configured in hardware to maintain a compiler, the compiler including instructions that are executable by the processor to perform the one or more operations to insert a data transfer node within a task graph having a plurality of computation nodes, the data transfer node configured to cause a data transfer operation using data aggregated from a plurality of tasks associated with the plurality of computation nodes.

In some aspects, the techniques described herein relate to a system, wherein the compiler is configured to insert the data transfer node within the task graph based a cost associated with an amount of time to perform data aggregation.

In some aspects, the techniques described herein relate to a system, wherein the compiler is configured to insert the data transfer node within the task graph based a cost associated with performing multiple data transfer operations to transfer the data.

In some aspects, the techniques described herein relate to a system, wherein the compiler is configured to: insert the data transfer node within the task graph based a route within the task graph, and select the route from a plurality of routes within the task graph.

In some aspects, the techniques described herein relate to a system, wherein the task graph is configured to specify execution of the plurality of tasks by a plurality of processing elements configured in hardware using circuitry for executing the plurality of tasks.

In some aspects, the techniques described herein relate to a system, wherein a command processor associated with the plurality of processing elements is configured to interpret the data transfer node to generate: a first data packet configured to initiate a direct memory access operation on a first said processing element that is to transmit the data, and a second data packet configured to complete the direct memory access operation on a second said processing element that is to receive the data.

In some aspects, the techniques described herein relate to a device including processing elements configured in hardware using circuitry for executing a plurality of tasks, and a command processor configured in hardware using circuitry to: schedule execution of the plurality of tasks by the processing elements, the plurality of tasks specified by a plurality of nodes in a task graph, and initiate a data transfer by a first said task of aggregated data from the first said task and a second said task, from which, the first said task depends.

In some aspects, the techniques described herein relate to a device, wherein the command processor is configured to initiate the data transfer based on a counter.

In some aspects, the techniques described herein relate to a device, wherein the counter includes a value based on a number of data dependencies identified for the first said task in the task graph.

In some aspects, the techniques described herein relate to a device, wherein the command processor is configured to initiate the data transfer responsive to detecting that the value of the counter indicates the first said task does not include a data dependency.

In some aspects, the techniques described herein relate to a device, further including a data transfer aggregation buffer configured to store the aggregated data.

In some aspects, the techniques described herein relate to a device, wherein the data transfer aggregation buffer is associated with a respective processing element of the processing elements that executes the first said task.

In some aspects, the techniques described herein relate to a device, wherein the command processor is configured to initiate the data transfer by dispatching a data transfer packet to a respective processing element of the processing elements that executes the first said task.

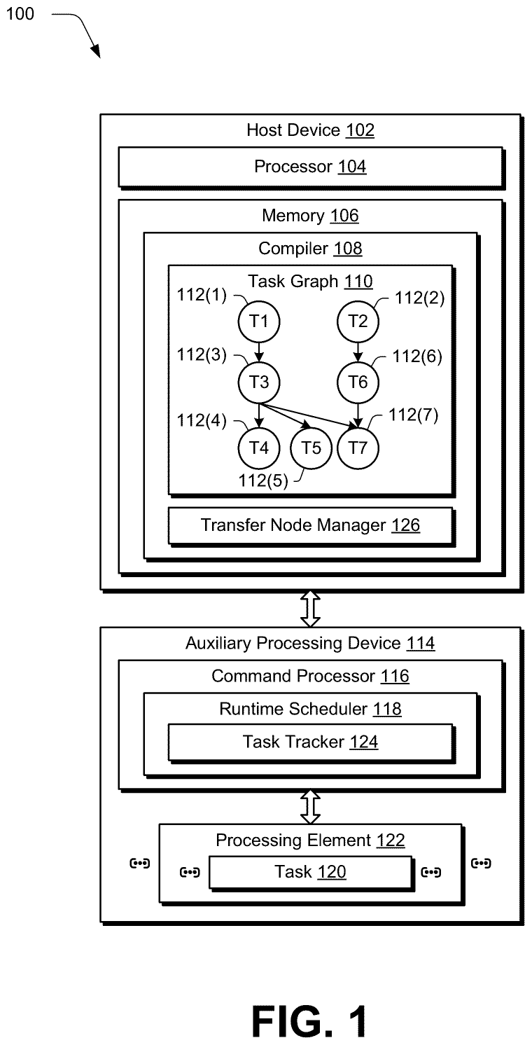

FIG. 1 is a block diagram of a non-limiting example system 100 configured to employ task graph control of data transfer techniques. The system 100 includes a host device 102. The host device 102 includes a processor 104 which represents any number of processor elements implemented in hardware using circuitry, e.g., one or more central processing units (CPUs). The host device 102 also includes memory 106 which is configurable as volatile or non-volatile memory elements as examples of computer-readable storage media implemented in hardware, e.g., using an integrated circuit on a printed circuit board.

The memory 106 is illustrated as maintaining a compiler 108. The compiler 108 is configurable as instructions that are maintained in the memory 106 and are executable by the processor 104 to perform operations. The compiler 108 in the illustrated example is configured to generate a task graph 110. The task graph 110 is a data structure that defines tasks that are to be “offloaded” in this example from the host device 102. The task graph 110, for instance, includes a plurality of nodes, examples of which are represented as a first node 112(1), second node 112(2), third node 112(3), fourth node 112(4), fifth node 112(5), sixth node 112(6), and seventh node 112(7). Each of the plurality of nodes represents a specific task to be performed, e.g., process data, move data, and so forth. The nodes 112(1)-112(7) are connected by edges (illustrated using arrows) that represent data dependencies between corresponding tasks. For example, the first node 112(1) and the second node 112(2) are not connected by an edge, and therefore these tasks may be executed in any order and/or in parallel. On the other hand, the first node 112(1) and the third node 112(3) are connected by an edge. Accordingly, a task associated with the first node 112(1) is executed and completed before initiating performed of the task associated with the third node 112(3). Therefore, as part of creating the task graph 110, the compiler 108 identifies tasks and data dependencies and then uses the edges to represent an order in which the tasks are to be executed.

An auxiliary processing device 114 receives the task graph 110. The auxiliary processing device 114 includes a command processor 116. The command processor 116 is configurable in hardware (e.g., using circuitry as part of an integrated circuit) to implement a hardware state machine or a programmable controller that executes firmware. The command processor 116, for instance, is configurable to implement a runtime scheduler 118 as a component of a runtime environment to schedule execution of tasks (e.g., illustrated as task 120) by corresponding processing elements, an example of which is illustrated as processing element 122.

The processing element 122 is configurable using hardware (e.g., circuitry as an integrated circuit) for executing the task 120. The processing element 122, for instance, is configurable as compute elements, data processing elements (DPEs), artificial intelligence (AI) elements, and the like. The auxiliary processing device 114 is therefore configurable as a graphics processing unit (GPU), field programmable gate array (FPGA), application specific integrated circuit (ASIC), system on a chip (SoC), and so on. The auxiliary processing device 114 may be implemented using a single integrated circuit or multiple integrated circuits, e.g., a base die coupled to chiplets.

The processing elements are configurable in a variety of ways. In a first example, the processing elements are arranged in an array. The array of processing elements can include a plurality of processing elements which may be arranged in a grid, cluster, or checkerboard pattern in the auxiliary processing device 114. In another example, the processing elements share a common configuration. That is, each of the processing elements (also referred to as tiles or blocks) may have the same hardware components or circuitry. Processing elements are also configurable as digital signal processing engines, cryptographic engines, forward error correction (FEC) engines, or other specialized hardware for performing one or more tasks. In a further example, the array includes different types of processing elements 122. For example, the array may include digital signal processing engines, cryptographic engines, graphic processing engines, and the like.

In yet another example, the processing elements are configurable from software-configurable hardened logic, i.e., are “hardened.” As a result, an amount of space consumed by the processing elements in the auxiliary processing device 114 is lessened relative to amount of space used by programmable logic to form the hardware elements in the processing elements. That is, using hardened logic circuitry to form the hardware elements in the processing elements such as program memories, an instruction fetch/decode unit, fixed-point vector units, floating-point vector units, arithmetic logic units (ALUs), multiply accumulators (MAC), and the like operate to significantly reduce a footprint of the array of the processing elements. Although the processing elements may be hardened, the processing elements are also programmable. That is, the processing elements are configurable when the auxiliary processing device 114 is “powered on” or rebooted to perform different tasks.

The host device 102 and the auxiliary processing device 114 are configurable for use in a variety of scenarios and corresponding devices. Examples of those devices include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the host device 102 and the auxiliary processing device 114 are configured as any one or more of those devices listed just above and/or a variety of other devices without departing from the spirit or scope of the described techniques.

As previously described, the tasks graph 110 is used by the host device 102 to schedule execution of the task 120 by the auxiliary processing device 114. Task graphs find use in parallel and distributed computing environments. Tasks graphs support efficient scheduling of tasks based on available resources, ensure tasks are executed in a correct order, and also maximize concurrency, e.g., parallel processing.

In some real-world scenarios, however, data dependencies specified in the task graph 110 introduce operation inefficiencies and technical challenges resulting from these inefficiencies. Frequent performance of data transfer for to copy a small amount of data between nodes, for instance, is detrimental to system performance of both the auxiliary processing device 114 and the host device 102. This is true especially in fine-grained tasks graphs having a significant number of edges and is particularly problematic for nodes that are relatively far apart in the task graph, e.g., involve multiple hops in a tiled architecture.

To address these and other technical challenges, task graph control techniques for data transfer are described. The task graph control techniques are usable to aggregate data from multiple tasks into an aggregated data transfer, thereby improving operational efficiency and device performance.

In a first example, the runtime scheduler 118 is executed on a command processor 116 of the auxiliary processing device 114. The runtime scheduler 118 implements a task tracker 124 to select a node during execution of tasks specified by the task graph 110. The selected node is utilized to transfer aggregated data from that node and a parent of that node, i.e., a node from which the selected node has a data dependency. In one or more examples, the task tracker 124 does so by using a counter having a value based on a number of data dependencies identified by the runtime scheduler 118 from the task graph. The value of the counter is adjusted by the task tracker 124 for each corresponding task when scheduled by the runtime scheduler 118 for execution by the processing element 122, upon communication of the task to the processing element 122, upon completion of the task by the processing element 122, and so forth.

Upon reaching a value that indicates that a corresponding node and tasks specified by that node no longer has a data dependency (e.g., a value of zero in a scenario in which the value of the counter is decremented), the task tracker 124 assigns the data transfer to that node to transfer data aggregated from the node and the parent nodes.

The runtime scheduler 118, for instance, maintains a set of counters, with each counter in the set associated with a specific node. Each counter is initialized by a number of parents, i.e., a number of data dependencies, identified from the task graph 110. When a node is dispatched, the runtime scheduler 118 decrements its children nodes' counters by one. A counter, upon reaching a zero value, indicates that a corresponding node from the task graph 110 that is currently being dispatched is the last non-dispatched parent of a child node. In response, the runtime scheduler 118 assigns the data transfer job to this node. The selected node performs the transfer of the aggregated data, e.g., to the tile where the child node is to be dispatched in the future.

In the illustrated task graph 110, for instance, in conventional techniques both the third node 112(3) and the sixth node 112(6) are tasked with performing separate data transfers of their output to the seventh node 112(7). Use of the counter by the runtime scheduler 118, however, enables selection of the last parent (e.g., the third node 112(3) or the sixth node 112(6)) to perform a single aggregated transfer for both the third node 112(3) and the sixth node 112(6). If the sixth node 112(6) is found to be the last parent (as this is not deterministic as described above), for instance, the sixth node 112(6) knows that the third node 112(3) aggregated its output previously in a local aggregation buffer which may then be transferred to a tile for the seventh node 112(7). The seventh node 112(7) is informed by the runtime scheduler 118 to expect this aggregated buffer as an input. Therefore, the seventh node 112(7) will receive the data transfer and synchronize its local memory with the aggregated buffer at the beginning of execution of a corresponding task. In this way, the technical challenges of conventional techniques caused by frequent data transfers using relatively small amounts of data are addressed, further discussion of which may be found in relation to FIGS. 2-3.

In a second example, the compiler 108 of the host device 102 is tasked with generating the task graph 110. As part of generating the task graph 110, the compiler 108 also inserts one or more data transfer nodes alongside computation nodes that specify tasks to be performed as described above. The location of the data transfer nodes within the task graph 110 is used to specify when a data transfer (e.g., a direct memory access) is to be performed.

As part of determining where to insert the data transfer node, the compiler 108 may address a variety of cost considerations. Examples of cost considerations include a cost associated with an amount of time to perform data aggregation, a cost associated with performing multiple data transfer operations to transfer the data, and so forth. The data transfer node is then interpreted by the command processor 116 (e.g., using a runtime scheduler 118) to generate a first data packet to initiate a direct memory access operation on a processing element associated with a producer node that is to transmit the aggregated data. The data transfer node is also interpreted by the command processor 116 to generate a second data packet configured to complete the direct memory access operation on another processing element associated with a consumer node that is to receive the data. Likewise, the technical challenges of conventional techniques caused by frequent data transfers using relatively small amounts of data are addressed, further discussion of which may be found in relation to FIGS. 4-5.

FIG. 2 is a block diagram of a non-limiting example system 200 configured to employ task graph control of data transfer techniques in which a runtime scheduler employs a counter to determine when to initiate a data transfer based on a task graph. The runtime scheduler 118 as part of the command processor 116 is able to achieve an entire view of the task graph 110 before tasks are scheduled. However, actual task dispatch ordering is not achievable due to out-of-order task completions.

To address this technical challenge, the runtime scheduler 118 implements a task tracker 124. The task tracker 124 utilizes a counter 204 generated by a counter creator 202. The counter 204 is included as part of a vector 206 to track data dependences within the task graph 110 for individual tasks. The vector 206 and individual counters 204 within the vector are then used by a counter manager 208 to determine when a node is encountered that does not have a subsequent data dependency, which is then used to initiate a transfer of aggregated data for corresponding tasks.

Accordingly, in this example the runtime scheduler 118, through use of the counter, tracks task dispatches to the processing elements 122(1)-122(2) dynamically to identify a last parent for each child task to assign the responsibility of an aggregated data transfer to that last parent. The runtime scheduler 118 does so by implementing a counter creator 202 (e.g., through execution of software by the command processor 116) to create a vector 206 of counters 204, one counter 204 for each task that represents a number of dependencies for a corresponding task. A counter manager 208 (e.g., implemented through execution of software by the command processor 116) is then utilized to adjust values of the counter 204. As tasks are dispatched by a task dispatcher 210 of the runtime scheduler 118, for instance, the counter manager 208 adjusts (e.g., decrements) a corresponding counter 204. The task that decreases a value of the counter 204 to zero in this example is identified by the counter manager 208 as the last parent, and as such, does not include a subsequent data dependency.

In an implementation, an application binary interface (ABI) is defined that allows tasks 120(1), 120(2) to own a set of metadata along with the actual computation data generated as part of the task. This data is stored, for example, in local memory of a processing element 122(1), 122(2), e.g., in a respective data transfer aggregation buffer 212(1), 212(2). The runtime scheduler 118 of the command processor 116 updates the metadata to inform the selected task to perform an aggregated data transfer, e.g., informs task 120(1) executed by the 122(1) in the illustrated example. The task 120(1) executing on the processing element 122(1) includes code to consult the metadata in the data transfer aggregation buffer 212(1) and perform the data transfer 216, using a local direct memory access (DMA) engine if applicable. As illustrated, the task 120(1) causes a data transfer 216 including aggregated data 214 from the data transfer aggregation buffer 212(1) to a processing element 122(2) that is to consume the aggregated data 214, e.g., through execution of task 120(2).

Thus, in this example task 120(1) appends data that is to be aggregated as part of the data transfer 216 into the data transfer aggregation buffer 212(1). The data is storable as a set of values and a set of indices. The last parent task (e.g., task 120(1)) selected by the runtime scheduler 118 performs the data transfer 216 (e.g., DMA operation) to transfer the data transfer aggregation buffer 212(1) to the processing element 122(1), at which, task 120(2) which is a consumer task of the parent task 120(1) is to be dispatched. The last parent task then clears the data transfer aggregation buffer 212(1) by resetting the write index. The runtime scheduler 118 is aware of the size of the data transfer aggregation buffer 212(1) and therefore is also configurable to perform runtime checks to avoid overflow.

For each identified last parent task, the runtime scheduler 118 creates and dispatches an extra data transfer packet to the processing element 122(1) executing the consumer task, e.g., task 120(2). This extra data transfer packet is usable to complete the DMA transfer of the data transfer aggregation buffer 212(1). In an implementation, the data transfer packet does not execute regular kernel code, but rather updates the local memory of the processing element 122(1) based on the aggregation buffer received in the sparse format. The metadata owned by the last parent task is used to inform the data transfer packet.

FIG. 3 is a flow diagram depicting a step-by-step procedure 300 in an example implementation of operations performable by a processing device for accomplishing a result of task graph control of data transfer using a runtime schedule implemented by a command processor. To begin in this example, a task graph is received (block 302). The task graph 110, for instance, is generated by a compiler 108 executed at a host device 102. The task graph 110 includes nodes specifying tasks and edges specifying data dependencies associated with the tasks.

Next, a runtime schedule 118 is executed by a command processor 116 of an auxiliary processing device 114. The runtime scheduler 118 schedules execution a plurality of tasks by the processing elements 122. The plurality of tasks is specified by a plurality of nodes in the task graph 110 (block 302).

The runtime scheduler 118 is configured to track execution of the plurality of tasks using a counter 204 through use of a task tracker 124. A value of the counter 204 is set by a counter creator 202 of the task tracker 124 based on a number of data dependencies identified for the plurality of tasks from the task graph 110 (block 304). The task tracker 124, for instance, is configurable to generate a vector 206 having a counter 204 for each of the tasks identified in the task graph 110 and a value based on a number of data dependencies identified for the tasks. A counter manager 208 of the task tracker 124 is then utilized to initiate a data transfer of aggregated data 214 from the plurality of tasks based on the counter 204 (block 306), e.g., when the counter 204 indicates a value that the corresponding task does not include further data dependencies. In this example, task graph control of data transfer is implemented at the runtime scheduler 118 and command processor 116 of the auxiliary processing device 114 that receives the task graph 110. Other examples are also contemplated in which task graph control is implemented as part of generation of the task graph 110 itself by a compiler 108 of the host device 102, an example of which is described as follows and is depicted in corresponding figures.

FIG. 4 is a block diagram of a non-limiting example system 400 configured to employ task graph control of data transfer techniques in which a compiler inserts a data transfer node as part of a task graph. In this example, the compiler 108 of the host device 102 generates the task graph 110. As part of generating the task graph 110, the compiler 108 employs a task graph generator 402 to generate the task graph 110 as previously described that includes computation nodes 404 defining tasks to be performed by respective processing elements 122 of the auxiliary processing device 114. The task graph 110 includes the computation nodes 404 and edges that define data dependencies between the computation nodes 404 as previously described.

The compiler 108, as part of creating the task graph 110, also includes the transfer node manager 126 that is representative of functionality (e.g., software executable by the processor 104 as part of the compiler 108) to insert a data transfer node 406 alongside the computation nodes 404 within the task graph 110. The location of the data transfer node 308 within the task graph 110 is used by the transfer node manager 126 to specify when a data transfer (e.g., a direct memory access) is to be performed by respective processing element 122.

The compiler 108, for instance, employs the transfer node manager 126 that is executable (e.g., as software by the processor 104) to determine a location in the task graph 110, at which, to insert a data transfer model alongside “regular” computation nodes 404 within the task graph 110 as the 1100 is being generated. The location of the data transfer node 406, therefore, is also usable to define an overall structure of the task graph 110, edit the structure of the task graph 110 as received by the task graph generator 402, and so on.

The location of data transfer node is used, upon processing by the runtime scheduler 118, to determine when the data transfer (e.g., DMA) is performed by respective tasks 120 as executed by respective processing elements 122. As previously described, a dispatch order of parent tasks is indeterministic due to the out-of-order nature of task completions. To address this, the transfer node manager 126 is configurable to insert the data transfer node before respective consumer nodes in the task graph 110 to ensure that each item of data having a data dependency is computed and aggregated before initiation of the data transfer. Similar to the above example of FIGS. 2 and 3, a data transfer aggregation buffer 212 is implemented in local memory of a respective processing element 122.

As part of determining where to insert the data transfer node 406, the transfer node manager 126 may address a variety of cost considerations. Examples of cost considerations include a cost associated with an amount of time to perform data aggregation, a cost associated with performing multiple data transfer operations to transfer the data, and so forth. The data transfer node 406 is then interpreted by the command processor 116 (e.g., using a runtime scheduler 118) to generate a first data packet to initiate a direct memory access operation on a processing element associated with a producer node that is to transmit the aggregated data. The data transfer node is also interpreted by the command processor 116 to generate a second data packet configured to complete the direct memory access operation on another processing element associated with a consumer node that is to receive the data.

The task graph generator 402 and the transfer node manager 126 may also be leveraged by the compiler 108 to make decisions about which route to use between nodes if the interconnect topology supports more than one. By knowing the interconnect topology and the graph dependencies, the compiler 108 may utilize a cost model to estimate bandwidth utilization and latency for whatever interconnections exist between nodes and apply an optimization for a given configuration.

A data transfer node is interpreted by the runtime scheduler 118, upon execution, to create and dispatch two data transfer packets. A first data transfer packet is usable in this example to initiate a data transfer (e.g., DMA) on the processing element 122, at which, the producer task is being executed. In order to complete the data transfer, a second data transfer packet is also generated by the runtime scheduler 118 to complete the data transfer operation (e.g., receipt of the DMA) on the processing element 122, at which, the consumer task is to be dispatched.

In an implementation, a kernel 408 executing on the processing element 122 is divided into two parts using a conditional statement. A first part is utilized for the actual computation involved in execution of the task and a second part is used to perform the data transfer, e.g., the DMA. The code to perform the data transfer (e.g., the DMA) is further divided into producer and consumer parts, i.e., for a “sender” and a “receiver” of the DMA. The producer releases a lock to trigger the data transfer (e.g., the DMA) while the receiver acquires a lock to acknowledge the receipt and updates the local memory. Data transfer packets cause the code of the kernel 408, when executed by the processing element 122, to take the data transfer path (e.g., a producer or consumer path) based on the information in the metadata maintained in the data transfer aggregation buffer 212. This example does not incur overhead by the runtime scheduler 118 to perform as the task dispatches are not tracked. However, this second example does result in a larger task graph 110 (e.g., with an extra data transfer node 406) and involves additional packet creation and dispatches.

FIG. 5 is a flow diagram depicting a step-by-step procedure 500 in an example implementation of operations performable by a processing device for accomplishing a result of task graph control of data transfer using a compiler to insert a data transfer node as part of a task graph. In this example, a compiler 108 maintained as instructions in memory 106 and as executed by a processor 104 inserts a data transfer node 406 within a task graph 110 having a plurality of computation nodes 404 (block 502). The data transfer node 406 is configured to cause a data transfer operation using data aggregated from a plurality of tasks associated with the plurality of computation nodes 404 (block 504), e.g., upon execution by a respective task by a respective processing element 122.

Thus, in both the task tracker 124 example as implemented by the runtime scheduler 118 and the transfer node manager 126 as implemented by the compiler 108, task graph control of data transfer is achieved to aggregate data from multiple tasks. In this way, instead of frequently copying relatively small amounts of data (e.g., which may not make full use of the interconnect bandwidth or require reconfiguration of switches between transfers), the task graph control techniques described herein batch the data transfers and perform a reduced number of data transfer operations. For scenarios involving task graphs with multiple edges and with a low compute to memory ratio, data transfers cause a significant portion of overall latency. Aggregating these data transfers reduces the number of data transfer operations performed on the interconnect and improves the application latency. For example, the techniques described herein are usable to reduce data transfers from “N” to “1” if there are “N” producers for a consumer task or if there is a single producer for “N” consumers. Additionally, these techniques support dynamic dispatch and scheduling of tasks on data-flow architecture, which improves performance and utilization over statically scheduled approaches for some real-world examples.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host device 102 and the auxiliary processing device 114) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A device comprising:
processing elements configured in hardware using circuitry for executing a plurality of tasks; and
a command processor configured in hardware using circuitry to:
schedule execution of the plurality of tasks by the processing elements, the plurality of tasks specified by a plurality of nodes in a task graph;
track execution of the plurality of tasks using a counter, wherein a value of the counter is set based on a number of data dependencies identified for the plurality of tasks from the task graph; and
initiate a data transfer of aggregated data from the plurality of tasks based on the counter.

2. The device of claim 1, wherein the plurality of nodes in the task graph are coupled using a plurality of edges that indicate the data dependencies between respective nodes of the plurality of nodes.

3. The device of claim 1, wherein the command processor is configured to initiate the data transfer responsive to detecting that the counter indicates a respective task of the plurality of tasks does not include a further data dependency.

4. The device of claim 1, further comprising a data transfer aggregation buffer, associated with a respective processing element of the plurality of processing elements, configured to store the aggregated data.

5. The device of claim 4, wherein the data transfer aggregation buffer is configured to maintain the aggregated data as:
a plurality of values that include data from respective tasks of the plurality of tasks; and
a plurality of indices that correspond to the plurality of tasks.

6. The device of claim 4, wherein the command processor is configured to perform a runtime check to detect overflow of the data transfer aggregation buffer.

7. The device of claim 1, wherein the command processor is configured to initiate the data transfer by dispatching a data transfer packet to a respective processing element of the processing elements that executes a respective task of the plurality of tasks that is indicated by the counter as not having a data dependency with another task of the plurality of tasks.

8. A system comprising:
a processor configured in hardware using circuitry to perform one or more operations; and
a memory configured in hardware to maintain a compiler, the compiler including instructions that are executable by the processor to perform the one or more operations to insert a data transfer node within a task graph having a plurality of computation nodes, the data transfer node configured to cause a data transfer operation using data aggregated from a plurality of tasks associated with the plurality of computation nodes.

9. The system of claim 8, wherein the compiler is configured to insert the data transfer node within the task graph based a cost associated with an amount of time to perform data aggregation.

10. The system of claim 8, wherein the compiler is configured to insert the data transfer node within the task graph based a cost associated with performing multiple data transfer operations to transfer the data.

11. The system of claim 8, wherein the compiler is configured to:
insert the data transfer node within the task graph based a route within the task graph; and
select the route from a plurality of routes within the task graph.

12. The system of claim 8, wherein the task graph is configured to specify execution of the plurality of tasks by a plurality of processing elements configured in hardware using circuitry for executing the plurality of tasks.

13. The system of claim 12, wherein a command processor associated with the plurality of processing elements is configured to interpret the data transfer node to generate:
a first data packet configured to initiate a direct memory access operation on a first said processing element that is to transmit the data; and
a second data packet configured to complete the direct memory access operation on a second said processing element that is to receive the data.

14. A device comprising:
processing elements configured in hardware using circuitry for executing a plurality of tasks; and
a command processor configured in hardware using circuitry to:
schedule execution of the plurality of tasks by the processing elements, the plurality of tasks specified by a plurality of nodes in a task graph; and
initiate a data transfer by a first said task of aggregated data from the first said task and a second said task, from which, the first said task depends.

15. The device of claim 14, wherein the command processor is configured to initiate the data transfer based on a counter.

16. The device of claim 15, wherein the counter includes a value based on a number of data dependencies identified for the first said task in the task graph.

17. The device of claim 16, wherein the command processor is configured to initiate the data transfer responsive to detecting that the value of the counter indicates the first said task does not include a data dependency.

18. The device of claim 14, further comprising a data transfer aggregation buffer configured to store the aggregated data.

19. The device of claim 18, wherein the data transfer aggregation buffer is associated with a respective processing element of the processing elements that executes the first said task.

20. The device of claim 14, wherein the command processor is configured to initiate the data transfer by dispatching a data transfer packet to a respective processing element of the processing elements that executes the first said task.
